(19) United States
(12) Patent Application Publication
(10) Pub. No.: US 2021/0295379 A1
(43) Pub. Date: Sep. 23, 2021

(54) SYSTEM AND METHOD FOR DETECTING FRAUDULENT ADVERTISEMENT TRAFFIC

(71) Applicant: COM OLHO IT PRIVATE LIMITED, Haryana (IN)

(72) Inventor: Abhinav Bangia, Haryana (IN)

(21) Appl. No.: 17/191,933

(22) Filed: Mar. 4, 2021

(30) Foreign Application Priority Data
Mar. 17, 2020 (IN) 202011011457

(51) Int. Cl. G06Q 30/02

(52) U.S. Cl. CPC G06Q 30/0248; G06Q 30/0277; G06N 20/00; G06Q 30/0272; G06Q 30/0201; G06Q 30/0246

(57) ABSTRACT

A system and a method for detecting fraudulent traffic relate to an advertisement are disclosed. A first set of parameters related to users' online activities on an online platform accessed through an online advertisement(s) are collected. The users' activities are collected over a predetermined period of time. Feature engineering is performed on the first set of parameters to obtain a second set of parameters. Dimensions of the second set of parameters are reduced to obtain a reduced set of parameters, and derive a plurality of data clusters from the reduced set of parameters. An optimal parameter set is identified from the reduced set of parameters based on highest variance among the reduced set of parameters. Anomalies present in a plurality of data clusters are identified to represent fraudulent traffic related to the advertisement.

### CROSS REFERENCE TO RELATED APPLICATION

This application claims priority to Indian Application No. 202011011457, filed Mar. 17, 2020, the disclosure of which is hereby incorporated in its entirety by reference herein.

### FIELD OF INVENTION

The present invention generally relates to a system and a method of detecting fraudulent advertisement traffic. More specifically, the present invention utilizes machine learning algorithms to deterministically identify presence of fraudulent advertisement traffic.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Advertisement fraud is a rising problem among advertisers, brands, and companies globally who spend on digital marketing. Various sources estimate the advertisement fraud to be almost 30-35% of the monthly expenses made on digital advertising.

Existing techniques for detection and prevention from advertisement frauds utilize parameters like Time to Install (TTI), Click Time to Install (CTTI), Events, Event Time, Internet Protocol (IP) addresses, Referral ID, percentage and moving averages. However, conventional techniques used for detection of advertisement fraud can be reverse engineered to avoid detection of the fraudulent advertisement sessions.

Therefore, there is a need of a technique that can deterministically detect presence of advertisement fraud and does not involve any scope of being reverse engineered.

### OBJECTS OF THE INVENTION

A general objective of the invention is to provide a system and a method for detecting fraudulent traffic related to an advertisement.

Another objective of the invention is to detect advertising fraud using big data analytics and machine learning techniques.

Yet another objective of the invention is to provide a technique for detection of organic hijacking and bot mixing in fraudulent advertisement traffic.

Still another objective of the invention is to verify presence of fraudulent advertisement traffic using Benford's law.

### SUMMARY OF THE INVENTION

This summary is provided to introduce aspects related to systems and methods configured to detect fraudulent advertisement traffic, and the aspects are further described below in the detailed description. This summary is not intended to identify essential features of the claimed subject matter nor is it intended for use in determining or limiting the scope of the claimed subject matter.

In an embodiment, a system and a method for detecting fraudulent traffic related to an advertisement are disclosed. A first set of parameters related to a users' activities on an online platform accessed through an online advertisement may be collected. The first set of parameters may comprise impression level parameters, click level parameters, install level parameters, and event level parameters. The users' activities may be collected over a predetermined period of time.

In an aspect, the impression level parameters may comprise impression time, location, device details, window size, video size, size of used memory, system clock time, and DomLoading. The click level parameters may comprise click time, location, and device details. The install level parameters may comprise install time, device details, application version, Software Development Kit (SDK) version, publisher, location, or Internet Protocol (IP) address. The event level parameters may comprise event time, location, device details, application version, SDK version, IP address, and publisher.

A second set of parameters may be derived by performing feature engineering on the first set of parameters. Dimensions of the second set of parameters may be reduced using a dimensionality reduction technique to obtain a reduced set of parameters and to generate a plurality of clusters. An optimal parameter set from the reduced set of parameters may be identified based on highest variance among the reduced set of parameters. Anomalies in the plurality of clusters may be identified based on the optimal parameter set. The anomalies may represent fraudulent traffic related to the advertisement. Structure and properties of the anomalies may be understood, and the anomalies may be classified based on payment, source, or geography, to detect fraudulent advertisement traffic.

Feature engineering may involve mathematical techniques such as imputation, numerical imputation, handling outliers, binning, log transform, one hot encoding, feature split, and scaling. The dimensionality reduction technique may be selected from a group consisting of Principal Component Analysis (PCA), Non-Negative Matrix Factorization (NMF), Kernel PCA, Graph-based kernel PCA, Linear Discriminant Analysis (LDA), Generalized Discriminant Analysis (GDA), Autoencoder, T-distributed Stochastic Neighbor Embedding (t-SNE), and Uniform Manifold Approximation and Projection (UMAP).

The structure and properties of the anomalies may be analyzed, and the anomalies may be classified based on payment status, source of transaction, and geography of transaction, to identify fraudulent traffic related to the advertisement. The structure and properties may be analyzed using Dunn index, Silhouette coefficient, or Inertia.

In another embodiment, presence of the fraudulent traffic related to the advertisement may be verified using Benford's law. The fraudulent traffic related to the advertisement may be deterministically detected during conversion. The conversion may correspond to a predefined action against clicking of the advertisement.

Other aspects and advantages of the invention will become apparent from the following description, taken in conjunction with the accompanying drawings, illustrating by way of example the principles of the invention.

### BRIEF DESCRIPTION OF THE DRAWINGS

The accompanying drawings constitute a part of the description and are used to provide a further understanding of the present invention.

FIG. 1 illustrates a network connection diagram of a system for detecting fraudulent advertisement traffic, in accordance with an embodiment of the present invention.

FIG. 2 illustrates a block diagram of a system for detecting fraudulent advertisement traffic, in accordance with an embodiment of the present invention.

FIG. 3 illustrates a flowchart of a method of detecting fraudulent advertisement traffic, in accordance with an embodiment of the present invention.

FIG. 4a illustrates a scatter plot prepared between a reduced component 1 and a reduced component 2 to show sources of transactions, in accordance with an embodiment of the present invention.

FIG. 4b illustrates a scatter plot prepared between the reduced component 1 and the reduced component 2 to illustrate payment status of different transactions, in accordance with an embodiment of the present invention.

FIG. 5a illustrates a scatter plot prepared between the reduced component 1 and the reduced component 2 showing fraudulent advertisement traffic related to the sources of transactions, in accordance with an embodiment of the present invention.

FIG. 5b illustrates a scatter plot prepared between the reduced component 1 and the reduced component 2 showing fraudulent advertisement traffic related to the payment status, in accordance with an embodiment of the present invention.

FIG. 6 illustrates Dunn Index for different data clusters, in accordance with another embodiment of the present invention.

FIG. 7a illustrates Silhouette plots for multiple data clusters, in accordance with another embodiment of the present invention.

FIG. 7b illustrates visualization of the multiple data clusters of Silhouette plots, in accordance with another embodiment of the present invention.

### DETAILED DESCRIPTION OF THE INVENTION

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

The present invention pertains to a system and a method for detecting fraudulent advertisement traffic. More specifically, the present invention utilizes big data analytics and machine learning algorithms, to deterministically detect presence of digital advertisement fraud.

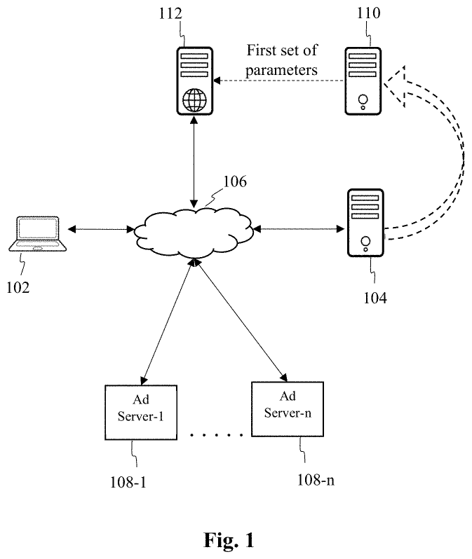

Referring now to FIG. 1, a network connection diagram of a system for detecting fraudulent advertisement traffic is explained. A user may utilize a user device 102 for accessing a first web page. The user device 102 may correspond to a variety of electronic devices that could be operated by the user, such as a mobile phone, a Personal Digital Assistant (PDA), a smartwatch, a computer, a desktop, and a laptop.

The first web page required to be accessed by the user may be hosted by a first web server 104. Therefore, to access the first web page, the user device 102 may connect with the first web server 104 through a communication network 106. The first web page may belong to any one of several categories, such as information websites, news websites, social media websites, microblogging websites, and electronic commerce websites. Along with information related to a relevant category, the first web page accessed by the user may include advertisements.

The advertisements could be served by a third party through one or more advertisement servers 108-1 through 108-n (collectively referred as advertisement servers 108). Such advertisement servers 108 may belong to a plurality of advertisers, publishers, advertisement and advertising agencies, to manage and run online advertising campaigns.

In one instance, when an advertisement present on the first web page hosted by the first web server 104 is clicked by the user, the user may be directed to a second web page linked with the advertisement. The second webpage linked with the advertisement may be hosted by a second web server 110.

A detection system 112 may be connected with the communication network 106 to detect fraudulent advertisement being posted on the first web page, and sessions established with the second web page through the fraudulent advertisement. To detect the fraudulent advertisement, the detection system 112 may collect a first set of parameters related to the user's activities on the first web page and the second web page. In one aspect, the first set of parameters may include details of online behavior of multiple users, collected over a predetermined period of time. The first set of parameters are processed to detect fraudulent traffic related to the advertisement.

In an aspect, at least some of the functionality of the detection system 112 may be provided by an Internet Service Provider (ISP). Alternatively, the detection system 112 may be installed, as a plugin, over the user device 102 to detect fraudulent advertisement traffic. Further, the detection system 112 could be deployed at the first web server 104 or the second web server 110.

The communication network 106 may be a wired and/or a wireless network. The communication network 106, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art.

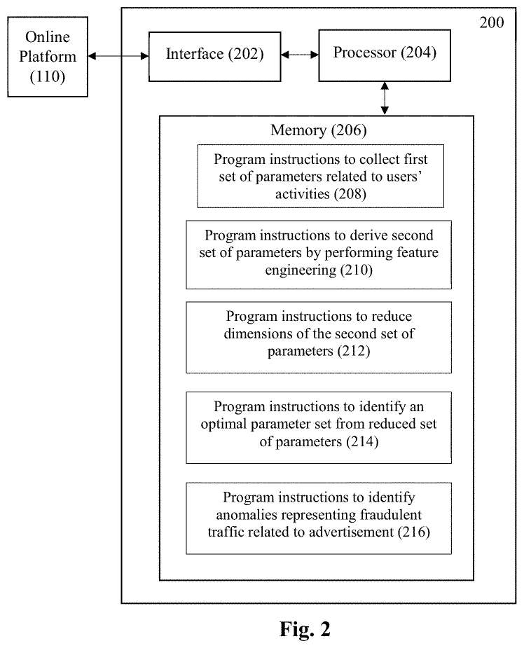

FIG. 2 illustrates a block diagram showing different components of a system 200 (similar to the detection system 112) for detecting fraudulent advertisement traffic, in accordance with an embodiment of the present invention. The system 200 may comprise an interface 202, a processor 204, and a memory 206. The memory 206 may store program instructions for performing several functions through which fraudulent advertisement traffic could be detected by the system 200. A few such program instructions stored in the memory 206 may include program instructions to collect first set of parameters related to users' activities 208, program instructions to derive second set of parameters by performing feature engineering 210, program instructions to reduce dimensions of the second set of parameters 212, program instructions to identify an optimal parameter set from reduced set of parameters 214, and program instructions to identify anomalies representing fraudulent traffic related to the advertisement 216. Detailed functioning of such program instructions will become evident upon reading the details provided successively.

The interface 202 may be used to collect a first set of parameters related to a users' activities, from the first web server 104 and/or the second web server 110. The interface 202 may be implemented as a Command Line Interface (CLI), Graphical User Interface (GUI). Further, Application Programming Interfaces (APIs) may also be used for remotely interacting with the computer network 106.

The processor 204 may include one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor), MIPS/ARM-class processor, a microprocessor, a digital signal processor, an application specific integrated circuit, a microcontroller, a state machine, or any type of programmable logic array.

The memory 206 may include, but is not limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

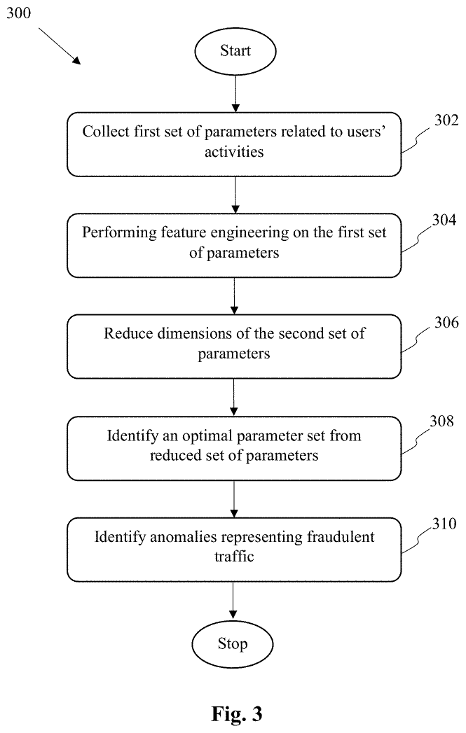

Referring now to FIG. 3 illustrating a flowchart 300, a method of detecting fraudulent advertisement traffic is described. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 3 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as decisions made by the program instructions 208 through 216.

At block 302, a first set of parameters related to users' activities on an online platform accessed through an online advertisement may be collected. The first set of parameters may comprise impression level parameters, click level parameters, install level parameters, and event level parameters. In an aspect, the users' activities may be collected over a predetermined period of time, for example 90 days. The users' online activities associated with advertisements may be represented as parameters, features, or data points, in a multi-dimensional space.

Further, the impression level parameters may comprise several details, such as an impression time, location, device details, window size, video size, size of the memory used, system clock time, and DomLoading. DomLoading is a time immediately before a user agent sets a current document readiness to ‘loading’, i.e. browser has the document and is about to perform some function with it. The click level parameters may comprise several details, such as a click time, location, and device details. The install level parameters may comprise several details, such as an install time, device details, application version, Software Development Kit (SDK) version, publisher information, location, and an Internet Protocol (IP) address. The event level parameters may comprise several details, such as an event time, location, device details, application version, SDK version, IP address, and publisher information.

At block 304, feature engineering may be performed on the first set of parameters to derive a second set of parameters. In one implementation, feature engineering may comprise several mathematical processing techniques, such as imputation, numerical imputation, handling outliers, binning, log transform, one hot encoding, feature split, and scaling. The second set of parameters obtained through feature engineering are utilized for improving performance of a data model. In an aspect, the system 200 may perform big data analytics and/or machine learning analysis on the first set of parameters and/or the second set of parameters to learn a pattern of progression.

Using imputation, empty or noise values present within the first set of parameters may be deleted. Deletion of the empty or noise values may prevent disruption of a data model when data corresponding to certain parameter(s) is missing or include noise. In one case, when a column in a data set includes 5% empty values, then rows of the data set corresponding to the empty values may be deleted. In another case, when a column in the data includes 95% empty values, then instead of rows, the column including the empty values may be deleted.

Additionally or alternatively, numerical imputation may be employed, i.e. estimated values may be filled in places where data is identified to be missing.

In another aspect, through handling outliers, each of the columns collected may be analyzed for descriptive statistics, i.e. mean, median, mode, and/or standard deviation. Upon such analysis, outlier columns may be removed as the outlier columns may disrupt the data model, by making it biased.

Using binning, columns may be separated. For example, device details are often received as device manufacturer's name and device name. Therefore, a device manufacturer's name may be stored in a first column and device name as second column may be separated to provide variety to the data model. For example, Samsung™ may be stored in the first column and “Galaxy S10” may be stored in the second column.

Using log transform technique, skewed data present in the first set of parameters, such as time to install, time to landing, time to event, and the like, may be log transformed, thereby drastically changing structure but allowing same variance.

In an aspect, one hot encoding technique may be utilized to derive a second parameter of the second set of parameters from a first parameter of the first set of parameters. One hot encoding is a process by which categorical variables are converted into a form that could be provided to a data model for a better prediction. For example, a user using an application for booking movie tickets may select cinema, place, location, movie, and meals. With each selection of the user, a data model may identify if the user is a moderate user or a heavy user. Upon such identification, a behaviour of the user may be predicted as soon as he signs up.

Using feature split technique, a set of parameters are split into training data and test data. A parameter such as device ID, may be broken down and with help of numerical imputation, and a unique numerical value may be assigned to broken parameters. This is because, disturbance in values in such columns may depict case of device farms fraud. A device farm is a location where fraudsters perform repeated actions, such as clicks, registrations, installs, and engagement, to create illusion of serving purposes of advertisements, thereby draining advertisement budget.

In another scenario, using scaling technique, independent features within a set of parameters may be standardized in a fixed range. For example, when numerical values do not differ significantly from each other, a constant, such as a value of 10ⁿ may be applied.

After obtaining the second set of parameters, using the several mathematical processing techniques described above, dimensions of the second set of parameters may be reduced, at block 306. The dimensions of the second set of parameters may be reduced using a dimensionality reduction technique, to obtain a reduced set of parameters. The dimensionality reduction technique may enable correct and quick processing of the second set of parameters. The dimensionality reduction technique may be selected from Principal Component Analysis (PCA), Non-Negative Matrix Factorization (NMF), Kernel PCA, Graph-based kernel PCA, Linear Discriminant Analysis (LDA), Generalized Discriminant Analysis (GDA), Autoencoder, T-distributed Stochastic Neighbor Embedding (t-SNE), and Uniform Manifold Approximation and Projection (UMAP).

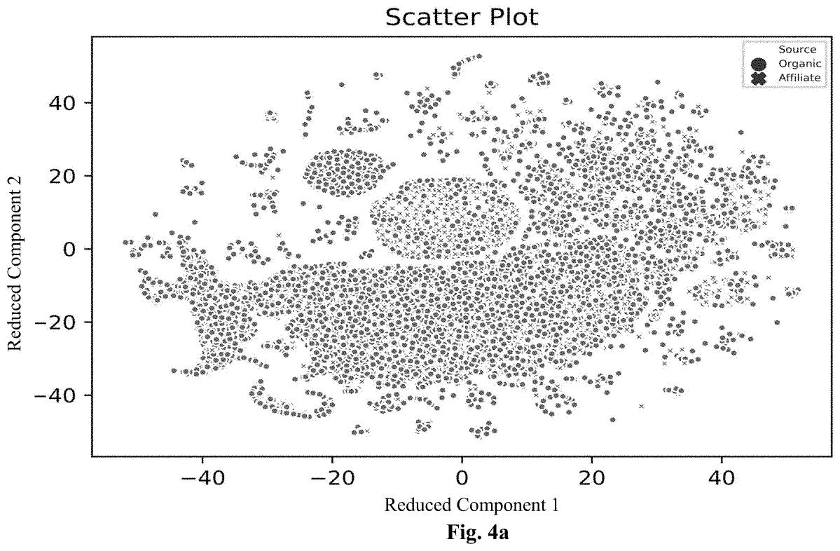

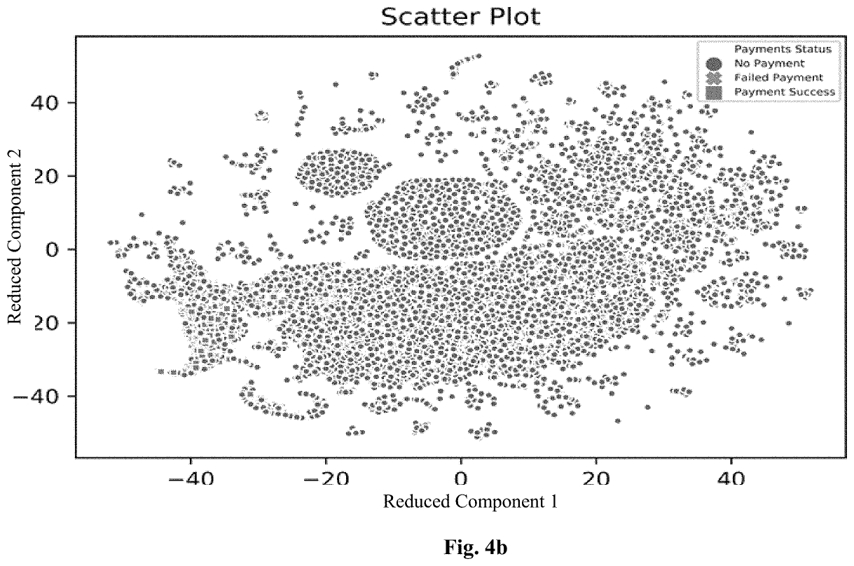

In an exemplary aspect, t-SNE may be used as the dimensionality reduction technique to generate the reduced set of parameters. t-SNE may find patterns in the second set of parameters by identifying clusters based on similarity of data points with multiple features. FIG. 4a illustrates a scatter plot prepared between a reduced component 1 and a reduced component 2 to show sources of transactions, i.e. Organic and Affiliate. Organic sources indicate data traffic from search engine excluding pair ads, and Affiliate sources indicate instances when an advertiser pays a blogger to promote his company. As illustrated in FIG. 4a, data points are grouped/clustered based on similarity of nearest neighbouring data points. Dimensionality reduction technique also suppresses noise and speeds up computation, since the parameters collected for multiple users over a predetermined period of time will be huge. Similarly, FIG. 4b illustrates a scatter plot prepared between the reduced component 1 and the reduced component 2 to illustrate payment status of different transactions, i.e. no payment, failed payment, and payment success.

Referring again to FIG. 3, at block 308, an optimal parameter set may be identified from the reduced set of parameters, based on highest variance among the reduced set of parameters. Variance (σ2) is known as a measurement of spread between numbers in a data set. Typically, variance is a square of difference of each value to its mean. In an aspect, several permutations and/or combinations calculations may be performed to obtain the optimal parameter set.

In one example, for a particular advertisement impression, the parameter DomLoading may have values of 1.1, 1.2, 1.3, 1.11, 1.23, and 1.43. It could be observed that the values do not vary much from a mean value, and thus this data series has a low variance. In such case, values of the parameter DomLoading will not help to distinguish between individual data points.

In another example, the parameter Click time to install may have values as 11, 20, 56, 102, and 180. It could be observed that the values vary much from a mean value, and thus this data series has a high variance. In such case, values of the parameter Click time to install will help to distinguish between individual data points.

The optimal parameter set optimally contributes to scatter plots by giving a distinctive behaviour. In an aspect, variance may be used to find the optimal parameter set. Using variance, a feature (data point) with higher value of variance is taken into consideration, while all other features with variance close to ‘0’ may not be considered as they would not provide distinction among data points.

At block 310, anomalies in a plurality of clusters may be identified based on the optimal parameter set. The anomalies may represent fraudulent traffic related to the advertisement. In an embodiment, upon understanding structure and properties of the anomalies, the anomalies may be classified based on payment status, source, and/or geography, to detect fraudulent advertisement traffic.

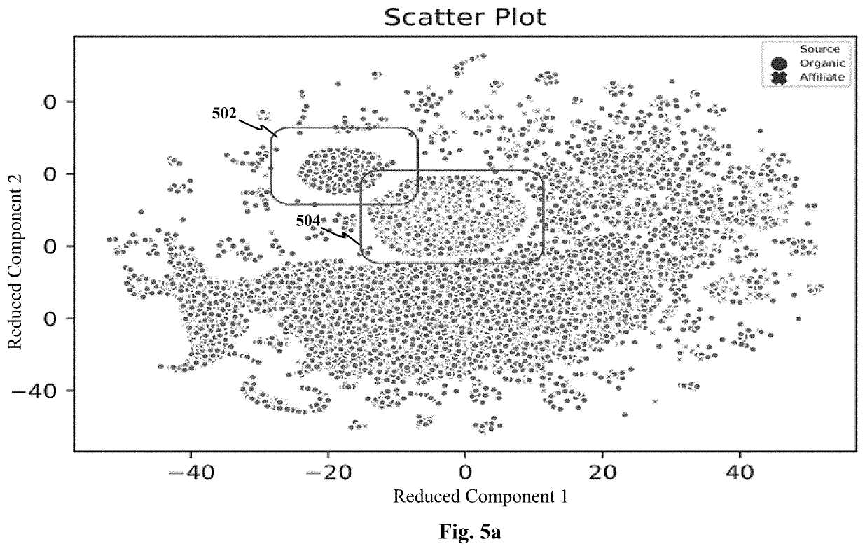

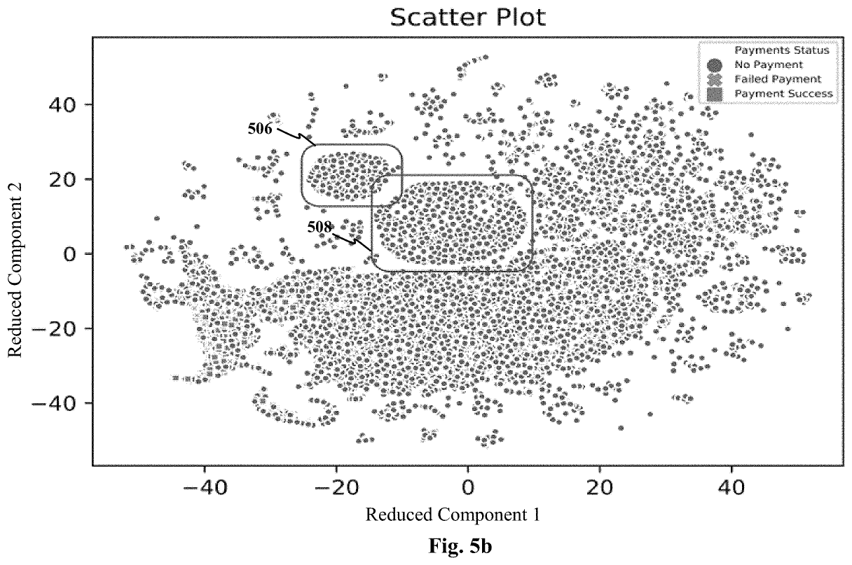

FIG. 5a illustrates a scatter plot prepared between the reduced component 1 and the reduced component 2 showing fraudulent advertisement traffic related to the sources of transactions, i.e. Organic and Affiliate. A data cluster 502 represents fraudulent traffic generated from organic sources, and a data cluster 504 represents fraudulent traffic generated from affiliate sources. Further, FIG. 5b illustrates a scatter plot prepared between the reduced component 1 and the reduced component 2 showing fraudulent advertisement traffic related to the payment status. A data cluster 506 and a data cluster 508 represent the fraudulent advertisement traffic indicating transactions for which payments were not made.

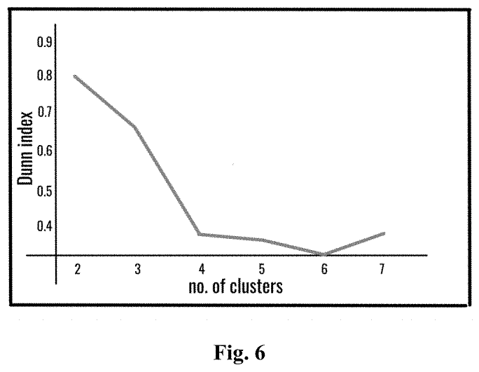

In an aspect, structure and properties of the data clusters may be analyzed using several metrics, such as Dunn index, Inertia, and Silhouette coefficient. FIG. 6 illustrates Dunn Index for different data clusters. A lower value of Dunn Index indicates accuracy of clustering algorithm. Similarly, Inertia states how data points within a cluster may exist. Generally, a low value of inertia is preferred.

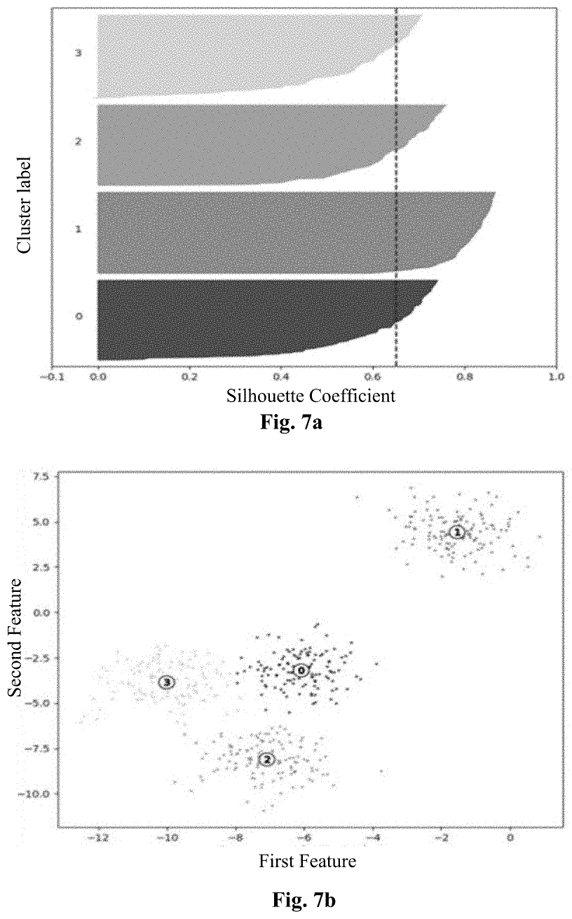

FIG. 7a illustrates Silhouette plots for multiple data clusters, and FIG. 7b illustrates visualization of the multiple data clusters of Silhouette plots. As illustrated in FIGS. 7a and 7b, four data clusters, i.e. cluster 0, cluster 1, cluster 2, and cluster 3 are formed using Silhouette coefficient. Silhouette coefficient may compare the multiple data clusters based on their tightness and separation. Referring closely to FIGS. 7a and 7b, cluster 1 could be observed to depict a different behaviour both in Silhoutte coefficient and feature location. Such deviation in behaviour either depicts a device farm or bots. Generally, this value has reference to Google/Facebook Traffic Indexes. Traffic provided by Google™ or Facebook™ could be used in benchmarking the traffic for quality. One reasons for utilizing such traffic is that 80% of traffic is supplied to the advertisers by Google™ and/or Facebook™. Such traffic helps in understanding organic hijacking or other kinds of advertisement frauds.

In another embodiment, various calculations might be performed on the advertisement data to arrive at a conclusion that at least some portion of the advertisement data is fraudulent. In one aspect, presence of the fraudulent advertisement traffic may be verified using Benford's law. Benford's law, also known law of anomalous numbers or first digit law, states that in listings, table of statistics, etc., a number leading with a digit “1” tend to occur with much greater probability than any other digit (i.e. from 2 to 9). Benford's law may be represented as

P(D=d)=Log₁₀(1+1/d)

where, d=1, 2, 3 . . . .

Using Benford's law, the system 200 may deterministically detect the fraudulent advertisement traffic at conversion. Conversion corresponds to an essential action, such as purchase or dialing/calling a business, against clicking of an advertisement.

In an aspect, the system 200 may deploy different types of hijacking techniques to claim the traffic generated either organically (by brand name) or by paid marketing ads on walled gardens such as Google, Facebook etc. Organic hijacking and/or bot mixing may be identified using the Benford's law.

Generally, time to install, and time to land on play store are relied on to understand the behavior of the advertisement traffic. Analyzing a behavior of the time to install feature may allow estimation of an amount of organic traffic that is being hijacked. This may allow an advertiser to understand if the advertiser is at a risk of financial and performance losses.

Bot traffic is often found to infect cost-per-impression, cost-per-install, or cost-per-engagement, in digital advertisements. Mixing is often looked at 40/60 to 30/70 percentage. Bot Mixing disturbs the probability distribution curve for the Benford's law. This happens because the traffic may be abnormally injected to give scale to performance campaigns.

In view of the above provided embodiments and their explanations, it is evident that the present invention provides a system and method to deterministically detect fraudulent advertisement traffic. By utilizing big data analytics and various machine learning techniques, the invention provides a novel method of detecting fraudulent advertisement traffic that cannot be reverse engineered by persons committing the advertisement frauds. Further, the invention also provides verification of presence of the fraudulent advertisement traffic using Benford's law.

The term “machine learning” refers broadly to an artificial intelligence technique in which a computer's behaviour evolves based on empirical data. In some cases, input empirical data may come from databases and yield patterns or predictions thought to be features of the mechanism that generated the data. Further, a major focus of machine learning is the design of algorithms that recognize complex patterns and makes intelligent decisions based on input data. Machine learning may incorporate a number of methods and techniques such as; supervised learning, unsupervised learning, reinforcement learning, multivariate analysis, case-based reasoning, backpropagation, and transduction.

Although implementations of a system and method for detecting fraudulent advertisement traffic have been described in language specific to structural features and/or methods, it is to be understood that the appended claims are not necessarily limited to the specific features or methods described. Rather, the specific features and methods are disclosed as examples of implementations of system and method for detecting fraudulent advertisement traffic.

We claim:

1. A method of identifying advertisement fraud, the method comprising:
collecting a first set of parameters related to users' activities on an online platform accessed through an online advertisement, wherein the first set of parameters comprise at least one of impression level parameters, click level parameters, install level parameters, and event level parameters, wherein the users' activities are collected over a predetermined period of time;
deriving a second set of parameters by performing feature engineering on the first set of parameters;
reducing dimensions of the second set of parameters using a dimensionality reduction technique to obtain a reduced set of parameters, and generating a plurality of data clusters from the reduced set of parameters;
identifying an optimal parameter set from the reduced set of parameters, wherein the optimal parameter set has highest variance among the reduced set of parameters; and
identifying anomalies present in the plurality of data clusters, based on the optimal parameter set, wherein the anomalies represent fraudulent traffic related to the advertisement.

2. The method as claimed in claim 1, wherein the impression level parameters comprise at least one of an impression time, location, device details, window size, video size, size of used memory, system clock time, and DomLoading.

3. The method as claimed in claim 1, wherein the click level parameters comprise at least one of a click time, location, and device details.

4. The method as claimed in claim 1, wherein the install level parameters comprise at least one of install time, device details, application version, Software Development Kit (SDK) version, publisher information, location, and an Internet Protocol (IP) address.

5. The method as claimed in claim 1, wherein the event level parameters comprise at least one of an event time, location, device details, application version, SDK version, IP address, and publisher information.

6. The method as claimed in claim 1, wherein the feature engineering comprises at least one of imputation, numerical imputation, handling outliers, binning, log transform, one hot encoding, feature split, and scaling.

7. The method as claimed in claim 1, wherein the dimensionality reduction technique is selected from a group consisting of Principal Component Analysis (PCA), Non-Negative Matrix Factorization (NMF), Kernel PCA, Graph-based kernel PCA, Linear Discriminant Analysis (LDA), Generalized Discriminant Analysis (GDA), Auto-encoder, T-distributed Stochastic Neighbor Embedding (t-SNE), and Uniform Manifold Approximation and Projection (UMAP).

8. The method as claimed in claim 1, further comprising analyzing structure and properties of the anomalies, and classifying the anomalies based on at least one of payment status, source of transaction, and geography of transaction, to identify the fraudulent traffic related to the advertisement, wherein the structure and properties are analyzed based on at least one of Dunn index, Silhouette coefficient, and Inertia.

9. The method as claimed in claim 1, further comprising:
verifying presence of the fraudulent traffic related to the advertisement using Benford's law; and
deterministically detecting the fraudulent traffic related to the advertisement at conversion, wherein the conversion corresponds to a predefined action against clicking of the advertisement.

10. A system comprising:
a processor; and
a memory connected to the processor, wherein the memory comprises programmed instructions which when executed by the processor, causes the processor to:
collect a first set of parameters related to users' activities on an online platform accessed through an online advertisement, wherein the first set of parameters comprise at least one of impression level parameters, click level parameters, install level parameters, and event level parameters, wherein the users' activities are collected over a predetermined period of time;
derive a second set of parameters by performing feature engineering on the first set of parameters;
reduce dimensions of the second set of parameters using a dimensionality reduction technique to obtain a reduced set of parameters, and generate a plurality of data clusters from the reduced set of parameters;
identify an optimal parameter set from the reduced set of parameters, wherein the optimal parameter set has highest variance among the reduced set of parameters; and
identify anomalies in the plurality of data clusters based on the optimal parameter set, wherein the anomalies represent fraudulent traffic related to the advertisement.
